(19) United States
(12) Patent Application Publication
(10) Pub. No.: US 2008/0163320 A1
(43) Pub. Date: Jul. 3, 2008

(54) Timezone-shifting IP-based video broadcasting system

(75) Inventors: Cheng-sean Chen, Los Altos, CA (US); Hung-yi Chen, Los Altos, CA (US)

Correspondence Address: REED SMITH LLP, Suite 1400, 3110 Fairview Park Drive, Falls Church, VA, 22042, US

(73) Assignee: Goosean Media Inc.

(21) Appl. No.: 11/645,755

(22) Filed: Dec. 27, 2006

(51) Int. Cl. H04N 7/173

(52) U.S. Cl. 725/112

(57) ABSTRACT

The present invention is to disclose an IP-based video broadcasting system for broadcasting video contents regarding TV programs to customers particularly from Asia regions particular to the Asian regions from Taiwan, Hong Kong, Macao, China, Korea, Japan, India, Vietnam, etc. via the internet or intranet. The system comprises a broadcasting apparatus and a plurality of client players, whereby the broadcasting apparatus comprises a timezone-shifting means, a timezone-non-shifting means, a language-selecting means, and a customer-profile means to provide customers with good quality of overseas TV broadcasting services.

### BACKGROUND OF THE INVENTION

1. Field of the Invention

The present invention relates to an IP-based video broadcasting system, and more particularly to a timezone-shifting IP-based video broadcasting system for delivering overseas TV programs with timezone-shifting and language-selecting feature.

2. Description of the Related Art

With the advent of networking communications technology, many people's daily lives are closely related to the Internet/Intranet business and are significantly impacted by the Internet/Intranet technology's evolution and revolution. More and more people have used the Internet/Intranet and even accessed/browsed the Internet/Intranet in their daily lives, whether for work, entertainment, shopping, or education, etc. The Internet/Intranet is creating a new economy, which is competing with people's traditional way of living.

It's known that IP-based TVs were proposed several years ago. IP-based TVs were proposed to provide people the possibility of obtaining internet/intranet access at a location, such as at home, by using only a regular PC with software installed or a device (e.g. set top box). Although people may enjoy watching video contents (e.g. television shows or programs) which have been broadcasted over the internet/intranet, however, some service providers for offering IP-based TVs do not guarantee the quality of services to customers since it's free. In addition, most of the local telecom carriers, on-line TV providers, and web-site companies provide the video content in their own mother or familiar languages rather than other foreign languages; for example, all the Asian Americans are difficult to receive the high quality of Asian TV programs which are originally broadcast in Asia.

To sum up, referred to FIG. 1 for illustrating a conventional IP-based TV system. The IP-based TV system 10 includes a TV content broadcasting center 11 is responsible to deliver the TV contents to the client players via the internet or intranet. It's no doubt that the IP-based TV system 10 serves the customers with English-spoken video contents. If the non-English native customers desire to receive the non-English TV contents from the system, for example, one Chinese user accesses to the client player 13, one Korean user accesses to the client player 14, and one Japanese user to the client player 15 for being desirous of watching his/her own native TV content delivered from the TV content broadcasting center 11, the system will get trouble in selection of different language types of TV contents so that the user needs cannot be satisfied.

U.S. Pat. No. 6,973,667 has disclosed an approach to delivering media program contents to customers through multicast or unicast, and wherein a multicast delivery unit and a unicast delivery unit will deliver the data packets for the media program to customers in a multicasting and unicasting fashions, respectively. Moreover, the patent is to provide the time-shifting feature such as TV programs recording in the client sides, and this feature does not solve the timezone issues when the customers desire to watch the overseas TV programs in the same broadcast time schedule as it is broadcast in the originating timezone like East Asia regions.

US Patent No. US20030097661 has disclosed a system for providing IP centric, multi-channel, telecommunication services such as television on demand, video on demand, karaoke on demand, Internet access, and telephone services. However the system disclosed by this invention merely provide customers with TV programs and customers have no language selections for receiving the TV programs originated by the specific language which is mother tongue to the customers.

Therefore, the present invention is to provide a system which allow the customers having other than English native speakers (particularly from the Asian regions around Taiwan, Hong Kong, Macao, China, Korea, Japan, India, Vietnam, etc.) to have language options for choosing what they want to watch and also move the watching style for the TV programs broadcasting in Asia to America through the internet or intranet. On the other hand, the customers in America may watch the overseas TV programs in the same broadcasting schedule as their originating country dependent on what language the customers choose.

### SUMMARY OF THE INVENTION

In order to solve the above mentioned problems, the present invention provides an IP-based video broadcasting system for broadcasting overseas video contents such as TV programs to customers via the internet or intranet, which comprises a broadcasting apparatus for storing and broadcasting a plurality of video contents; and a plurality of client players for, each of the client players accessed by the customers located in one of the timezones in America, receiving the plurality of video contents from the broadcasting apparatus via the internet or intranet based on video streaming; wherein said broadcasting apparatus comprises a timezone-shifting means for adjusting the timezone shift between the content originating overseas timezone and the customer watching local timezone so as to deliver the video content to the client player in timezone-shifting fashion; a timezone-non-shifting means for controlling the delivery of said video contents broadcasted at the originating timezone to the customers in the almost same broadcast time; a language-selecting means for, in response to a request provided by the client player, providing the video content originated by a specific language to the client player which customers access in said language; and a customer-profile means for, when each of the client players accessing the system, storing and analyzing the customer data to develop a customer profile for each of the plurality of client players.

Therefore, the object of the present invention is to provide a business model related to a TV broadcasting system which is capable of adjusting the timezone shift between the content originating overseas timezone and the customer watching local timezone, and delivering the overseas TV programs to customers such that the customers in one timezone (e.g. California in US) can watch the overseas TV programs at the same broadcast schedule as the overseas TV programs currently broadcasted in Asia countries another timezone (e.g. Taiwan).

Yet another object of the present invention is to provide a business model related to a TV broadcasting system which provides customers with a language selection of watching the overseas TV programs originated in the specific language.

Yet another object of the present invention is to provide a business model related to a TV broadcasting system which adds a plurality of virtual servers therein to improve the quality of broadcast bandwidth over the internet and/or intranet.

### BRIEF DESCRIPTION OF THE DRAWINGS

FIG. 1 is an illustration of the conventional broadcasting system;

FIG. 2A is an illustration of the broadcasting system according to the first preferable embodiment of the present invention;

FIG. 2B is an illustration of the timezone-shifting means in the broadcasting system according to the first preferable embodiment of the present invention;

FIG. 2C is an illustration of the timezone-non-shifting means in the broadcasting system according to the first preferable embodiment of the present invention; and

FIG. 3 is an illustration of the broadcasting system according to the second preferable embodiment of the present invention.

FIG. 4 is an illustration of the broadcasting system according to the third preferable embodiment of the present invention.

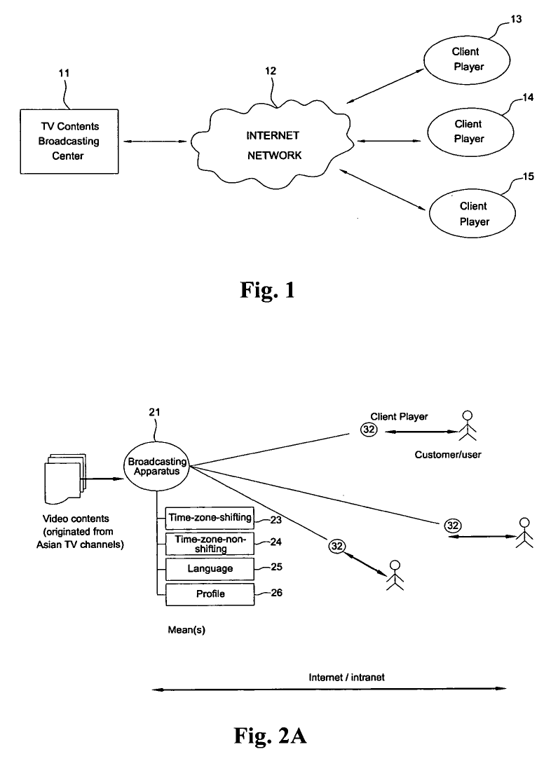

### DETAILED DESCRIPTION OF THE EMBODIMENTS

Since the present invention discloses a broadcasting system used in delivering the video contents via the internet and/or intranet, wherein the basic principles or techniques of the network communications are well-known by those skilled in the art, the following description will omit the description of the principles. Moreover, the diagrams included in the following are not completely drawn according to the real size and are only used to demonstrate features related to the present invention.

The present invention relates to a business model for providing the domestic non-English native spoken customers with an environment which creates the life style for watching the overseas TV programs originated from multiple Asian TV channels from Taiwan, Hong Kong, Macao, China, Korea, Japan, India, Vietnam, etc. in the same broadcast schedule.

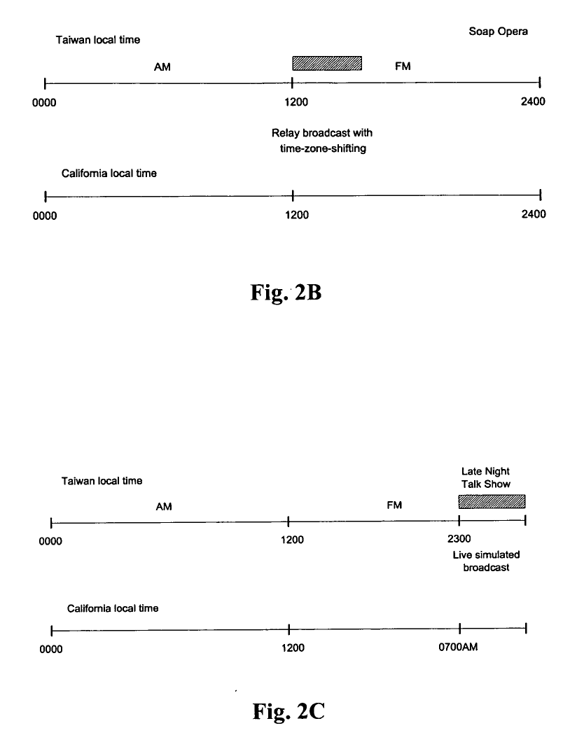

FIG. 2A is an IP-based video broadcasting system according to the first preferable embodiment of the present invention. The broadcasting system 20 is provided to deliver video contents such as overseas TV programs to customers over the internet or intranet. The broadcasting system 20 comprises a broadcasting apparatus 21 and a plurality of client players 22. The broadcasting apparatus 21 stores a plurality of video contents originated from the Asia countries particularly to Taiwan, Hong Kong, Macao, China, Korea, Japan, India, Vietnam, etc., and delivers the plurality of video contents to customers in a broadcasting fashion based on the video streaming compression via the internet or intranet. The plurality of client players 22, which are performed by software or device (e.g. set top box) and accessed by the customer or customers, receive the plurality of video contents from the broadcasting apparatus 21 over the internet or intranet. The broadcasting apparatus 21 includes a timezone-shifting means 23, a timezone-non-shifting means 24, a language-selecting means 25 and a customer-profile means 26.

The function of said timezone-shifting means 23 is to control the delivery of overseas video contents and/or TV programs to the customer/user in the local desired timezone or in the same broadcast time schedule as the content originating country. For example, referred to FIG. 2B, the customers in the west coast of US may watch the Taiwan 1200 pm soap opera replayed at US local 1200 pm on the D day and the timezone difference is existent between the broadcast timezone in one originating country (e.g. Taiwan) and the replay timezone in another receiving country (e.g. US). In other words, the customers in US may watch the 24-hour TV programs following the same TV broadcast schedule as any other Asian regions.

The function of said timezone-non-shifting 24 is to control the delivery of the overseas video contents and/or TV programs to the customer/user in the almost same broadcast time or later (i.e. a couple of minutes lag). For example, referred to FIG. 2C, the customers in the west coast of US at 1200 PM may watch on the D day the at-noon News which is currently broadcast at 0400 AM on the D+1 Day in Taiwan. In other words, the customers in US may watch almost the live or minute-of-delay overseas TV programs when the same TV program is currently broadcast in any other Asian originating country.

The function of said language-selecting means 25 is to provide the customer/user with selection of a specific language for watching the overseas video contents and/or TV programs originated by a specific language or country in response to a request provided by the customer/user. For example, a Japanese customer/user may select the TV programs broadcasted in Japanese language in Japan.

The customer-profile means 26 is to store and analyze each customer/user data to develop a customer/user profile based on each of the plurality of client players 22 when each of the client players access the system 20, and enables the broadcasting apparatus 21 to provide the personalized services in customized fashion. For example, a group of customers may prefer to watch the adult oriented TV programs no mater who are from Taiwan, Hong Kong, Macao, China, Korea, Japan, India, Vietnam, etc.

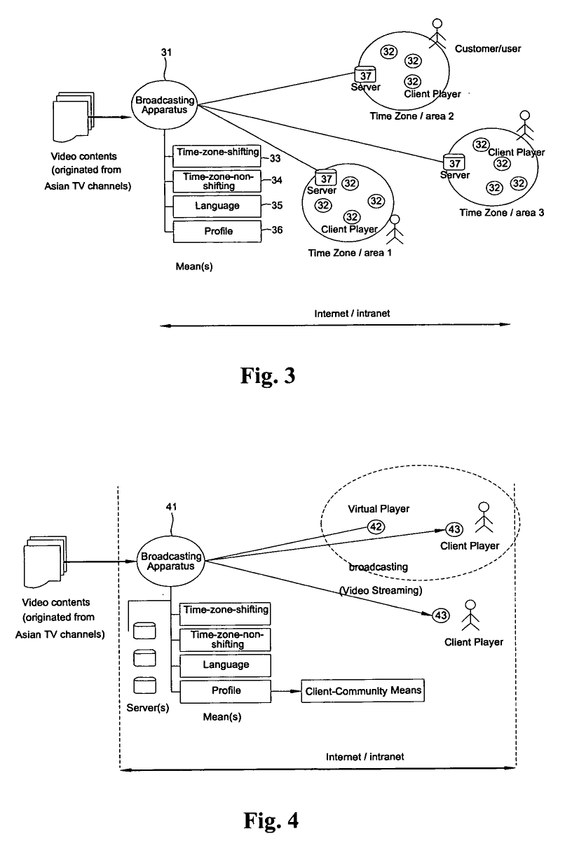

FIG. 3 is another IP-based video broadcasting system according to the second preferable embodiment of the present invention. The broadcasting system 30 comprises a broadcasting apparatus 31 and a plurality of client players 32. The broadcasting apparatus 31 includes a timezone-shifting means 33, a timezone-non-shifting means 34, a language-selecting means 35 and a customer-profile means 36. Besides, the broadcasting apparatus 31 further comprises one or more servers 37 for performing at least one operation of video storing, video streaming, web accessing, proxy managing, and cache buffering during data communication between the broadcasting apparatus 31 and the client players 32. The servers 37 are allocated in the different timezones and/or the different geographical areas for serving the neighboring customers. The timezone-shifting means 33 is configured by said server 37 or said client players 32 for adjusting the timezone to watch the video content so as to control the delivery of overseas video contents and/or TV programs to the customer/user in the local desired timezone or in the same broadcast time schedule as the content originating country. Moreover, the broadcasting apparatus 31 further comprises a customer-community means 38 for grouping the customers into one or more communities based on the customer/user data from the customer-profile means and for providing the customer with personalized services based on the interest of the community. The technical features and relating structures for all the timezone-shifting means 33, the timezone-non-shifting means 34, the language-selecting means 35 and the customer-profile means 36 are described in the first embodiment.

FIG. 4 is yet another IP-based video broadcasting system according to the third preferable embodiment of the present invention. The broadcasting system 40 comprises a broadcasting apparatus 41, a plurality of virtual servers 42 and a plurality of client players 43. The broadcasting apparatus 41 stores a plurality of video contents or TV programs originated from the Asia countries particularly to Taiwan, Hong Kong, Macao, China, Korea, Japan, India, Vietnam, etc., and delivers the plurality of video contents to customers in a broadcasting fashion based on the video streaming compression via the internet or intranet. Besides, the technical features and relating structures of the broadcasting apparatus 41 are described in the second preferable embodiment. The plurality of virtual servers 42 are provided in the embodiment for improving the quality of delivery of the overseas video contents or TV programs to the client players during the traffic jam in data communication, and the broadcasting apparatus 41 will determine the number of virtual servers 42 for serving the neighboring client players 43 based on the content loading and dynamic bandwidth allocation at that time. The plurality of client players 43, which are performed by software or device (e.g. set top box) and accessed by the customer or customers, receive the plurality of video contents from the broadcasting apparatus 41 over the internet or intranet.

The above mentioned preferred embodiments of the present invention are not meant to limit the scope of the present invention. The description of the present invention should be understood by those skilled in the art. Moreover, any changes or modifications or the equivalent thereof that can be made without departing from spirit of the present invention should be protected by the following claims.

What is claimed is:

1. An IP-based video broadcasting system for broadcasting video contents to customers via the internet or intranet, comprising:
a broadcasting apparatus for storing and broadcasting a plurality of video contents; and
a plurality of client players for receiving the plurality of video contents from the broadcasting apparatus via the internet or intranet based on video streaming;
wherein said broadcasting apparatus comprises:
a timezone-shifting means for adjusting the timezone shift between the content originating overseas timezone and the customer watching local timezone so as to deliver the video contents to the client players;
a timezone-non-shifting means for controlling the delivery of said video contents broadcasted at the overseas originating timezone to the client player received at the local watching timezone in almost the same broadcast time;
a language-selecting means for, in response to a request provided by the client player, providing the video content originated by a specific language to the client player to which customers access in said language; and
a customer-profile means for, when each of the client players accessing the system, storing and analyzing the customer data to develop a customer profile for each of the plurality of client players.

2. The IP-based video broadcasting system of claim 1, wherein the broadcasting apparatus further comprises one or more servers for performing at least one operation of video storing, video streaming, web accessing, proxy managing, and cache buffering.

3. The IP-based video broadcasting system of claim 2, wherein the servers are allocated in different timezones and/or different geographical areas.

4. The IP-based video broadcasting system of claim 2, wherein the timezone-shifting means is configured by said server or said client players.

5. The IP-based video broadcasting system of claim 1, wherein the plurality of video contents are originated from multiple Asian TV broadcast channels.

6. The IP-based video broadcasting system of claim 5, wherein the multiple Asian TV broadcast channels are selected from the areas consisting of Taiwan, Hong Kong, Macao, China, Korea, Japan, India, and Vietnam.

7. The IP-based video broadcasting system of claim 1, further comprising a customer-community means for grouping the customers into one or more communities based on the customer data from the customer-profile means and providing the customer with personalized services based on the interest of the community.

8. The IP-based video broadcasting system of claim 1, wherein the originating area is selected from the group consisting of Taiwan, Hong Kong, Macao, China, Korea, Japan, India, and Vietnam.

9. The IP-based video broadcasting system of claim 1, wherein the language is selected from the group consisting of Taiwan, Hong Kong, Macao, China, Korea, Japan, India, and Vietnam.

10. The IP-based video broadcasting system of claim 1, further comprising a plurality of virtual servers invoked by said broadcasting apparatus for improving the quality of delivery of the video contents to the client players through the communication link over the internet or intranet.

11. The IP-based video broadcasting system of claim 1, wherein the client player is accessible to the customer.

12. The IP-based video broadcasting system of claim 1, wherein timezone-non-shifting means controls the delivery of the video contents from the broadcasting apparatus to the client player in an allowable lag delay within a number of minutes.

13. The IP-based video broadcasting system of claim 1, wherein the video contents are one of the TV programs, movie videos or the like.

14. An IP-based video broadcasting system for broadcasting video contents to customers via the internet or intranet, comprising:
a broadcasting apparatus for storing and broadcasting a plurality of video contents;
a plurality of client players for, each of the client players accessed by the customer, receiving the plurality of video contents from the broadcasting apparatus via the internet or intranet based on video streaming; and
a plurality of virtual servers invoked by said broadcasting apparatus for improving the quality of delivery of the video contents to the client players;
wherein said broadcasting apparatus comprises:
a timezone-shifting means for adjusting the timezone shift between the content originating overseas timezone and the customer watching local timezone so as to deliver the video contents to the client players disposed in different timezones and/or geographical locations;
a language-selecting means for, in response to a request provided by the client player, providing the video content originated by a specific language to the client player which customers access in said language; and
a customer-profile means for, when each of the client players accessing the system, storing and analyzing the customer data to develop a customer profile for each of the plurality of client players.

15. An IP-based video broadcasting system for broadcasting video contents to customers via the internet or intranet, comprising:
a broadcasting apparatus for storing and broadcasting a plurality of video contents;
a plurality of client players for, each of the client players accessed by the customer, receiving the plurality of video contents from the broadcasting apparatus via the internet or intranet based on video streaming; and
a plurality of virtual servers invoked by said broadcasting apparatus for improving the quality of delivery of the video contents to the client players;
wherein said broadcasting apparatus comprises:
a timezone-shifting means for adjusting the timezone shift between the content originating timezone and the customer watching local timezone so as to deliver the video contents to the client player disposed in different timezones and/or geographical locations; and
a language-selecting means for, in response to a request provided by the client player, providing the video content originated by a specific language to the client player which customers access in said language.
